(19) United States
(12) Patent Application Publication
(10) Pub. No.: US 2008/0129611 A1
(43) Pub. Date: Jun. 5, 2008

(54) ANTENNA MODULE AND ELECTRONIC DEVICE USING THE SAME

(75) Inventor: Kai-Li Jiang, Jiangsu Province (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: QISDA CORPORATION, Taoyuan Shien (TW)

(21) Appl. No.: 11/945,303

(22) Filed: Nov. 27, 2007

(30) Foreign Application Priority Data
Dec. 4, 2006 (TW) 95145026

(51) Int. Cl. H01Q 9/04; H01Q 1/22

(52) U.S. Cl. 343/702; 343/700 MS

(57) ABSTRACT

An antenna module and an electronic device using the same are provided. The antenna module includes an antenna component and a parasitic element. The antenna component includes a feeding portion used for being electrically connected to a circuit board of the electronic device. The parasitic element is disposed adjacent to the feeding portion of the antenna component and substantially parallel to the feeding portion, wherein the parasitic element is coupled with the electromagnetic field of the feeding portion for causing a resonance in the antenna component, such that the antenna component produces a signal having multiple frequency bands.

This application claims the benefit of Taiwan application Serial No. 95145026, filed on Dec. 4, 2006, the subject matter of which is incorporated herein by reference.

### BACKGROUND OF THE INVENTION

1. Field of the Invention

The invention relates in general to an antenna module and an electronic device using the same, and more particularly to an antenna module having multiple frequency bands and an electronic device using the same.

2. Description of the Related Art

In recent years, wireless communication products have become the mainstream communication products. Wireless communication, such as wireless network and mobile communication, which dispenses with complicated lines and is not subjected to local use, has gained rapid advancement. Meanwhile, various portable electronic devices such as notebook computer, mobile phone, digital camera and PDA all have the features of compactness, slimness, lightweight and small size. Particularly, the mobile phone, with the advancement in communication and network technology, requires the antenna not only to cover a wide range of frequency bands but also possess the features of slimness, compactness, light weight and small size.

### SUMMARY OF THE INVENTION

The invention is directed to an antenna module and an electronic device using the same. A parasitic element of the antenna module is coupled with the electromagnetic field of the feeding portion for causing a resonance in the antenna module. The antenna module inputs a signal having multiple frequency bands to the electronic device, such that the electronic device is capable of operating within a range of different frequency bands and complies with many communication protocols.

According to a first aspect of the present invention, an antenna module used in an electronic device having a circuit board is provided. The antenna module includes an antenna component and a parasitic element. The antenna component includes a feeding portion used for being electrically connected to the circuit board. The parasitic element is disposed adjacent to the feeding portion of the antenna component and the extension direction of the parasitic element is parallel to the feeding portion, wherein the parasitic element is coupled with the electromagnetic field of the feeding portion for causing a resonance in the antenna component, such that the antenna component produces a signal having multiple frequency bands.

According to a second aspect of the present invention, an electronic device including a circuit board and an antenna module is provided. The antenna module includes an antenna component and a parasitic element. A feeding portion of the antenna component is electrically connected to the circuit board. The parasitic element is disposed adjacent to the feeding port ion and the extension direction of the parasitic element is parallel to the feeding portion, wherein the parasitic element is coupled with the electromagnetic field of the feeding portion for causing a resonance in the antenna component, such that the antenna component produces a signal having multiple frequency bands.

The invention will become apparent from the following detailed description of the preferred but non-limiting embodiments. The following description is made with reference to the accompanying drawings.

### BRIEF DESCRIPTION OF THE DRAWINGS

FIG. 1 is a perspective of an electronic device according to a preferred embodiment of the invention;

FIGS. 2A˜2C illustrate the parasitic element located on different positions of a substrate;

FIG. 3 is a perspective of the main piece and the secondary piece form a spiral shape;

FIG. 4A is a return loss diagram of the antenna module without a parasitic element; and

FIG. 4B is a return loss diagram of the antenna module of FIG. 1.

### DETAILED DESCRIPTION OF THE INVENTION

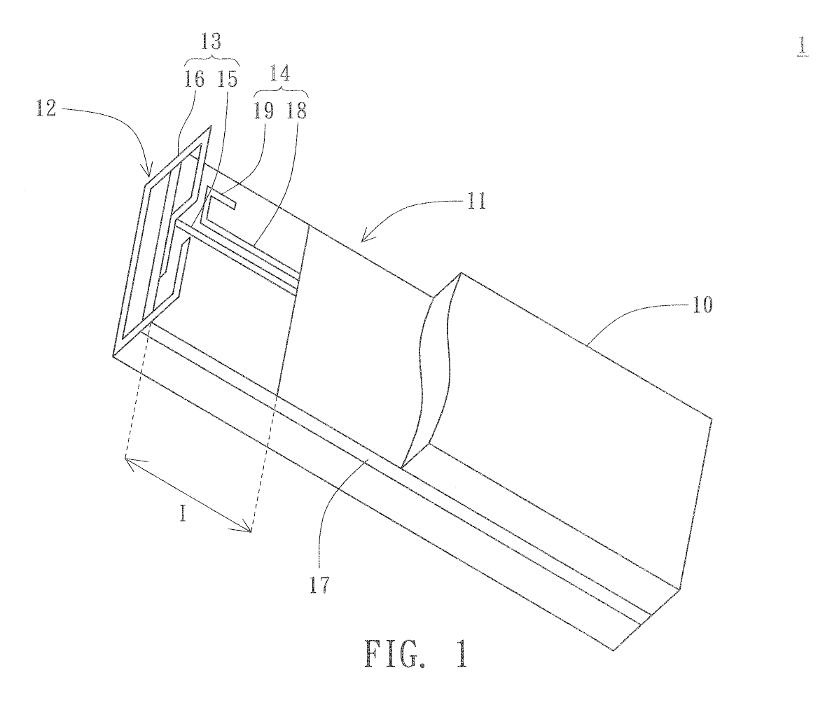

Referring to FIG. 1, a perspective of an electronic device according to a preferred embodiment of the invention is shown. The electronic device of the present embodiment of the invention is exemplified by a communication mobile phone. As indicated in FIG. 1, a device body 10 of the electronic device 1 includes a circuit board 11 and an antenna module 12. The antenna module 12 includes an antenna component 13 and a parasitic element 14. The antenna component 13 includes a feeding portion 15 used for being electrically connected to the circuit board 11. The parasitic element 14 is disposed adjacent to a feeding portion 15 of the antenna component 13 and the extension direction of the antenna component 13 is parallel to the feeding portion 15. The parasitic element 14 is coupled with the electromagnetic field of the feeding portion 15 for causing a resonance in the antenna component, such that the antenna component 13 inputs a signal having multiple frequency bands to the circuit board 11.

The antenna component 13 has an antenna body 16 connected to the feeding portion 15 for receiving/sending a signal. The antenna body 16 and the feeding portion 15 are disposed on two different planes respectively. Preferably, the two planes are substantially perpendicular to each other, such that there is no interference between the feeding portion 15 and the antenna body 16. The antenna component 13 is exemplified by a low profile planar monopole antenna (one kind of the microstrip antenna) possessing the features of small size and lightweight, hence applicable to many electronic products of mobile communication. The circuit board 11 is exemplified by a printed circuit board, wherein a substrate 17 of the circuit board 11 has a clearance I for separating the antenna body 16 from the circuit board 11 to avoid the circuit elements on the circuit board 17 having mutual electromagnetic interference with the antenna body 16. The feeding portion 15 of the antenna component 13 is exemplified by a feeding line. The feeding line and the parasitic element 14 disposed on the same lateral of the substrate 17 are substantially parallel to each other and located in the clearance I of the substrate 17. In FIG. 1, the parasitic element 14 is disposed to the right of the feeding portion 15.

The parasitic element 14 exemplified by a η shape has a main piece 18 and a secondary piece 19 connected to the main piece 18. The main piece 18 is substantially parallel to the feeding portion 15 and connected to a reference ground. Usually, the circuit board 11 of the electronic device 1 can be used as a reference ground. That is, the main piece 18 is connected to the circuit board 11 directly. The parasitic element 14 is pasted or printed on the substrate 17 of the circuit board 11, and is preferably made from a conductive material. For example, the parasitic element 14 is a copper element pasted on the substrate 17; or, the parasitic element 14 is electroplated on the substrate 17 during the manufacturing process of the circuit board 11.

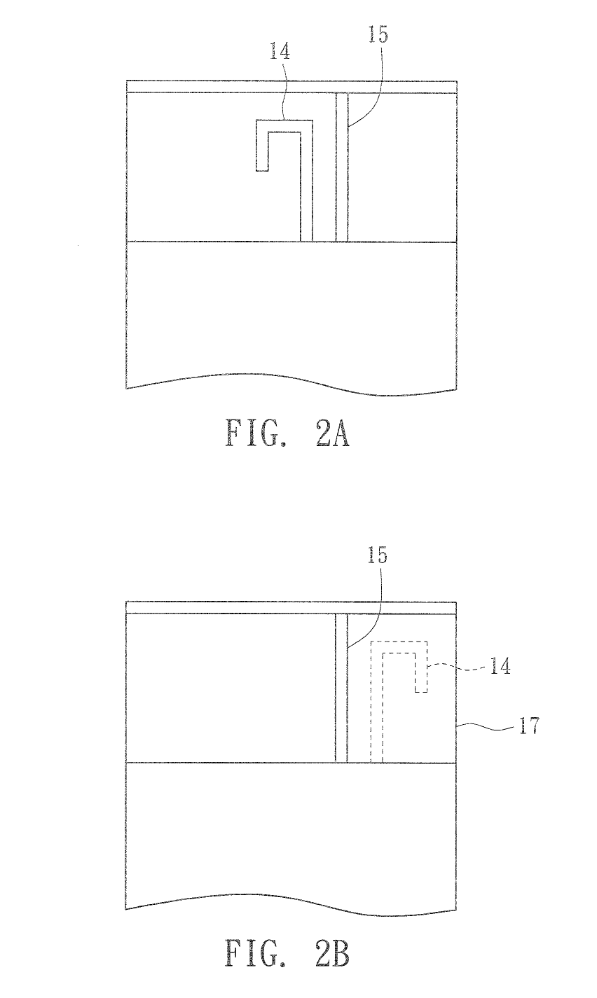

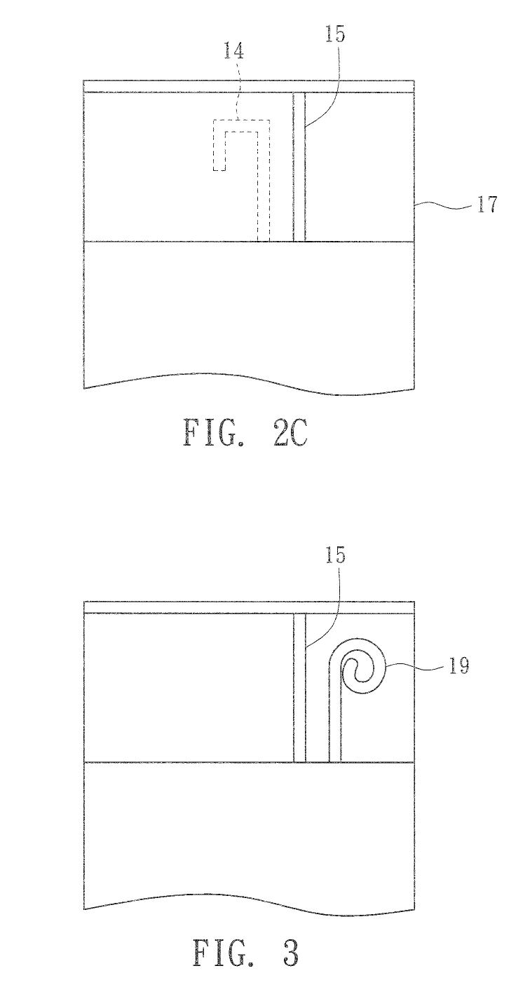

Despite the parasitic element 14 is disposed on the clearance I in the present embodiment of the invention, the parasitic element 14 can be disposed on other positions of the substrate 17 to fit other accessories of the electronic device 1 such as a speaker or a lens. Referring to FIGS. 2A˜2C, perspectives of the parasitic element located on different positions of a substrate are shown. As indicated in FIG. 2A, the parasitic element 14 can also be disposed to the left of the feeding portion 15. As indicated in FIGS. 2B˜2C, the parasitic element 14 is disposed on another lateral of the substrate 17. Referring to FIG. 3, a perspective of the main piece and the secondary piece form a spiral shape is shown. As indicated in FIG. 3, the main piece 18 and the secondary piece 19 of the parasitic element 14 can form an L shape structure as well as a spiral shape structure. The spiral shape structure enables the secondary piece 19 to have enough length under the condition that only limited space is available.

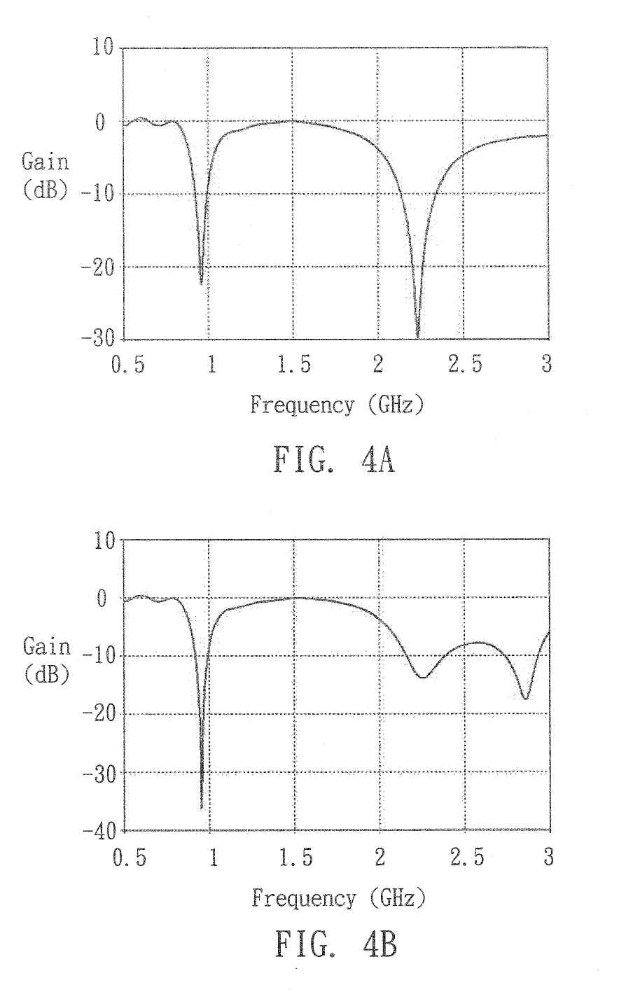

The function of the antenna module 12 in the electronic device 1 is stated below. Referring to FIG. 4A, a return loss diagram of the antenna module of FIG. 1 without a parasitic element is shown. The return loss (RL) is defined as the power ratio of the signal inputted to a signal transmitting system to the reflected signal received by the signal source. By measuring the return loss, the antenna properties of the antenna module are obtained. As stated above, the antenna body 16 in FIG. 1 is exemplified by a low profile planar monopole antenna. With the specific structural design, the antenna body 16 has two resonance frequency bands. As indicated in FIG. 4A, the antenna body 16 can function properly within the ranges of the two resonance frequency bands. The resonance frequency band of the antenna body 16 is determined according to the length and material of the antenna body 16, such that the antenna body 16 can function within the range of a given frequency band. As indicated in FIG. 4A, before the parasitic element 14 is installed, the two resonance frequency bands of the antenna body 16 are respectively at the range of 0.9 GHz to 1 GHz and the range of 2.2 GHz to 2.3 GHz. Within the two ranges, the antenna body 16 has a larger gain, that is, less return loss.

Referring to FIG. 4B, a return loss diagram of the antenna module in FIG. 1 is shown. The electromagnetic field of the feeding portion 15 of the antenna component 13 is coupled with the main piece 18 of the parasitic element 14 to cause a resonance. Therefore, when the return loss of the antenna module 12 in FIG. 1 is measured, the antenna component 13 will generate an additional resonance frequency. As indicated in FIG. 4B, there are three resonance frequency bands at the range of 0.9 GHz˜1 GHz, 2.2 GHz˜2.3 GHz, and 2.7 GHz˜2.8 GHz, respectively, such that the antenna module 12 can function properly within the three resonance frequency bands. The range of the additional resonance frequency band almost covers up to 3.0 GHz.

The frequency band of the antenna module 12 has much to do with the clearance I on the substrate 17, the physical length, electrical length, and material of the parasitic element 14, and the disposition of the parasitic element 14. For example, as indicated in FIG. 1, the main piece 18 of the parasitic element 14 must be close enough to the feeding portion 15 for the feeding portion 15 and the main piece 18 to generate a coupling effect, and the feeding portion 15 must be parallel to the main piece 18. The physical length of the parasitic element 14 refers to the length of the main piece 18 and that of the secondary piece 19. The electrical length of the parasitic element 14 is determined according to the physical length, the reference ground, and the material. The electrical length of the parasitic element 14 is defined as a quarter of the wavelength, that is, (¼)λ, wherein λ is the wavelength of the electromagnetic wave that can be radiated or received by the antenna and is expressed as λ=(C/F), C denotes the velocity of light, and F denotes frequency.

Normally, the resonance frequency of the antenna component 13 of the antenna module 12 is already set when the antenna component 13 is manufactured. Then an appropriate parasitic element 14 is designed according to the frequency band and disposed on a particular position on the circuit board 11 corresponding to the feeding portion 15, such that a desired resonance frequency band is obtained during operation. Or, the desired resonance frequency band is obtained by adjusting the length of the secondary piece 19 of the parasitic element 14. In the present embodiment of the invention, the antenna module 12 complies with the communication protocols such as GSM850/900, DCS/PCS/WCDMA or TD-SCDMA of 3G protocols. Under some design conditions, the antenna module of the invention can even cover up to a frequency band of 2.4 GHz.

The parasitic element 14 of the present embodiment of the invention has a simple structure and and can be formed via easy manufacturing process. By adjusting the electrical length, disposition or other features of the parasitic element 14, the antenna module 12 can cover wide ranges of resonance frequencies. Besides, the parasitic element 14 and the antenna body 16 are respectively disposed on two different planes. Preferably, the two different planes are perpendicular to each other, such that the coupling of electromagnetic field will occur only between the parasitic element 14 and the feeding portion 15. Therefore, the resonance of the antenna body 16 will not be affected when the resonance frequency of the parasitic element 14 is adjusted.

Despite the electronic device 1 is exemplified by a communication mobile phone in the present embodiment of the invention, the antenna module 12 in the present embodiment of the invention can also be applied to other electronic devices possessing multiple frequency communication functions such as PDA and GPS.

According to the antenna module and the electronic device using the same disclosed on the above embodiment of the invention, the parasitic element of the antenna module is coupled with the electromagnetic field of the feeding portion of the antenna component for causing a resonance, such that higher resonance frequency and more frequency bands are generated. The parasitic element is parallel to the feeding portion and is not disposed on the same plane with the antenna body of the antenna module to avoid interference with the resonance frequency of the antenna body, wherein the antenna body is used for receiving/sending a signal. Besides, the parasitic element is easy to manufacture. By adjusting the parasitic element, the electronic device can have more frequency bands. The antenna module and the electronic device of the invention comply with many of the current communication protocols.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An antenna module used in an electronic device having a circuit board, the antenna module comprising:
an antenna component having a feeding portion used for being electrically connected to the circuit board; and
a parasitic element disposed adjacent to the feeding portion of the antenna component and an extension direction of the parastic element parallel to the feeding portion, wherein the parasitic element is coupled with the electromagnetic field of the feeding portion for causing a resonance in the antenna component, such that the antenna component produces a signal having multiple frequency bands.

2. The antenna module according to claim 1, wherein the parasitic element comprises a main piece and a secondary piece connected to the main piece, the electronic device has a reference ground, and the main piece is substantially connected to the reference ground.

3. The antenna module according to claim 2, wherein the main piece is substantially parallel to the feeding portion.

4. The antenna module according to claim 2, wherein the main piece is substantially connected to the circuit board.

5. The antenna module according to claim 2, wherein the main piece and the secondary piece form an L shape structure.

6. The antenna module according to claim 2, wherein the main piece and the secondary piece form a screw shape structure.

7. The antenna module according to claim 2, wherein the main piece and the secondary piece form a η shape structure.

8. The antenna module according to claim 1, wherein the antenna component comprises an antenna body connected to the feeding portion, there is a gap between the antenna body and the circuit board, and the feeding portion and the parasitic element are located in the gap and disposed on a substrate of the circuit board.

9. The antenna module according to claim 8, wherein the parasitic element and the antenna body are disposed on two different planes.

10. The antenna module according to claim 9, wherein the parasitic element is disposed on a first plane, and the antenna body is disposed on a second plane that is substantially perpendicular to the first plane.

11. The antenna module according to claim 8, wherein the parasitic element and the feeding portion are disposed on the same lateral of the substrate.

12. The antenna module according to claim 8, wherein the parasitic element is pasted on the substrate.

13. The antenna module according to claim 8, wherein the parasitic element is printed on the substrate.

14. An electronic device, comprising:
a circuit board; and
an antenna module having an antenna component and a parasitic element, wherein a feeding portion of the antenna component is electrically connected to the circuit board, the parasitic element is disposed adjacent to the feeding portion of the antenna component, and an extention direction of the parastic element is parallel to the feeding portion, the parasitic element is coupled with the electromagnetic field of the feeding portion for causing a resonance in the antenna component, such that the antenna component produces a signal having multiple frequency bands.

15. The electronic device according to claim 14, further comprising a reference ground, wherein the parasitic element comprises a main piece substantially connected to the reference ground and a secondary piece connected to the main piece.

16. The electronic device according to claim 15, wherein the main piece is substantially parallel to the feeding portion.

17. The electronic device according to claim 15, wherein the main piece is substantially connected to the circuit board.

18. The electronic device according to claim 15, wherein the main piece and the secondary piece form an L shape structure.

19. The electronic device according to claim 15, wherein the main piece and the secondary piece form a screw shape structure.

20. The electronic device according to claim 15, wherein the main piece and the secondary piece form a η shape structure.

21. The electronic device according to claim 14, wherein the antenna component comprises an antenna body connected to the feeding portion, there is a gap between the antenna body and the circuit board, and the feeding portion and the parasitic element are located in the gap and disposed on a substrate of the circuit board.

22. The electronic device according to claim 21, wherein the parasitic element and the antenna body are disposed on two different planes.

23. The electronic device according to claim 22, wherein the parasitic element is disposed on a first plane, and the antenna body is disposed on a second plane that is substantially perpendicular to the first plane.

24. The electronic device according to claim 21, wherein the parasitic element and the feeding portion are disposed on the same lateral of the substrate.
